(19) United States
(12) Patent Application Publication
(10) Pub. No.: US 2008/0220215 A1
(43) Pub. Date: Sep. 11, 2008

(54) Method and apparatus for engraving a decorative item and the item decorated thereby

(76) Inventors: Conrad Mercurius, Long Pond, PA (US); Andrea A. Mercurius, Long Pond, PA (US)

Correspondence Address: JAMES RAY & ASSOCIATES, 2640 Pitcairn Road, Monroeville, PA, 15146, US

(21) Appl. No.: 12/074,526

(22) Filed: Mar. 4, 2008

Related U.S. Application Data
(60) Provisional application No. 60/892,978, filed on Mar. 5, 2007.

(51) Int. Cl. B44B 3/02; B32B 3/00; B44C 1/22; B23C 1/06; B23Q 15/007; G06F 19/00; B23Q 35/00

(52) U.S. Cl. 428/156; 700/159; 409/84; 409/116

(57) ABSTRACT

A method of engraving includes providing a computer data system capable of receiving information, transmitting information, creating files, storing files, and editing files. Providing an engraving software compatible with such computer data system. Operably connecting the engraving software to such computer data system. Creating a file within such computer data system for use with the engraving software, such file containing predetermined information for engraving on an engravable item. Operably connecting an engraving mechanism to such computer data system for receiving instructional information relating to engraving from such computer data system. Transmitting such instructional information from such computer data system to the engraving mechanism. Providing an engravable item. Operably connecting the engravable item to the engraving mechanism such that the engravable item is engraved according to such instructional information and such that the engravable item depicts a copy of such predetermined information once engraving is complete.

### CROSS REFERENCE TO RELATED APPLICATION

This patent application is related to and claims priority from U.S. Provisional Patent Application Ser. No. 60/892,978 filed Mar. 5, 2007.

### FIELD OF THE INVENTION

The present invention relates, in general, to engraved items and engraving devices and, more particularly, this invention relates to a method and apparatus for engraving and the product of same.

### BACKGROUND OF THE INVENTION

Prior to the conception and development of the present invention, engraving, as is generally well known in the prior art, has been used on metals and wood for decorative and informational purposes.

### SUMMARY OF THE INVENTION

The present invention provides a method of engraving. Such method of engraving includes providing a computer data system capable of receiving information, transmitting information, creating files, storing files, and editing files. Providing an engraving software compatible with such computer data system. Operably connecting the engraving software to such computer data system. Creating a file within such computer data system for use with the engraving software, such file containing predetermined information for engraving on an engravable item. Operably connecting an engraving means to such computer data system for receiving instructional information relating to engraving from such computer data system. Transmitting such instructional information from such computer data system to the engraving means. Providing an engravable item. Operably connecting the engravable item to the engraving means such that such engravable item is engraved according to such instructional information and such that the engravable item depicts a copy of such predetermined information once engraving is complete.

According to another embodiment, an apparatus for engraving is provided. Such apparatus includes a computer data system capable of receiving information, transmitting information, creating files, storing files, and editing files. Engraving software is disposed within such computer data system, such engraving software being operably connected to such computer data system for receiving and transmitting information. A means for inputting information into at least one of such engraving software and such computer data system is operably connected to such computer data system. An engraving means is operably connected to such computer data system for receiving instructional information relating to engraving such that the engraving means is capable of engraving an engravable item according to such instructional information such that the engravable item depicts predetermined information. A means for connecting such engraving means to such engravable item during engraving is operably connected to such engraving means at a predetermined location thereon.

According to still another embodiment, an engraved decorative item is provided. Such engraved decorative item includes a decorative member manufactured from a first predetermined material and having a first predetermined size and a first predetermined shape and having at least one engravable surface at a first predetermined location thereon. An engraved depiction is disposed on such decorative member at a second predetermined location thereon.

### OBJECTS OF THE INVENTION

It is, therefore, one of the primary objects of the present invention to provide a method of engraving which is easy to use and cost effective.

Another object of the present invention is to provide a method of engraving using a desktop computer connected to an engraving machine.

Still another object of the present invention is to provide a method of etching glass and plastic.

Yet another object of the present invention is to provide a means to create decorative and resilient copies of sentimentally meaningful documents.

An additional object of the present invention is to provide decorative engraved and etched items suitable for display by a user.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which an engraved decorative item having wedding invitation information engraved thereon is depicted.

FIG. 2 is a top view of the invention according to one embodiment of the invention in which an engraved decorative item is depicted.

FIG. 3 is a partial perspective view of the invention according to one embodiment of the invention in which a front view of engraved decorative item having wedding invitation information engraved thereon is provided.

FIG. 4 is a partial perspective view of the invention according to one embodiment of the invention in which a rear view of an engraved decorative item having wedding invitation information engraved thereon is provided.

FIG. 5 is a partial perspective view of the invention according to one embodiment of the invention in which an engraved decorative item having wedding invitation information engraved thereon is attached to a stand.

FIG. 6 is a partial schematic view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

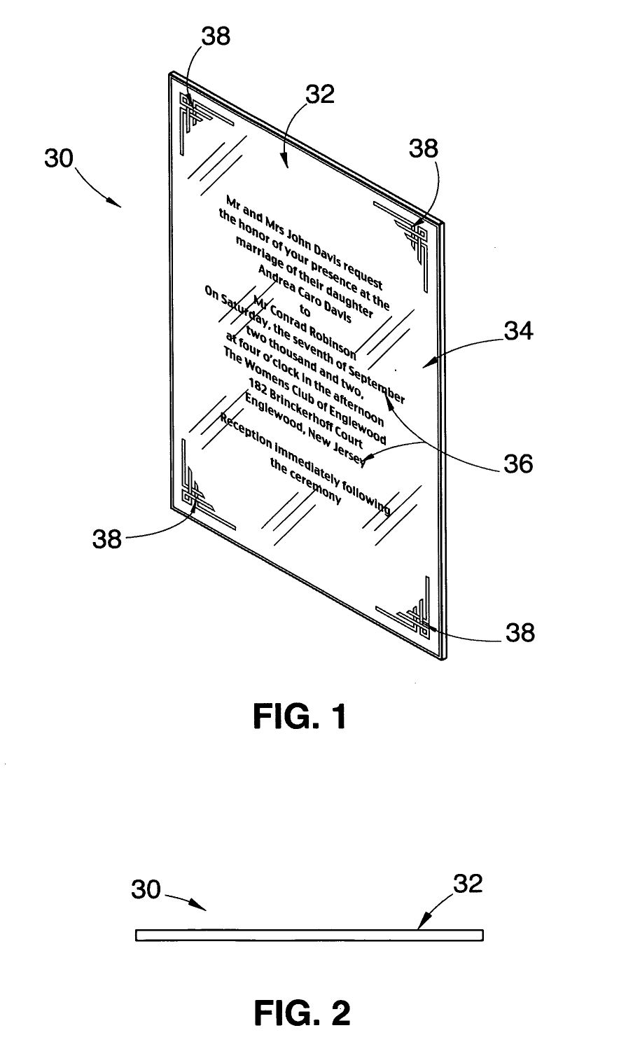

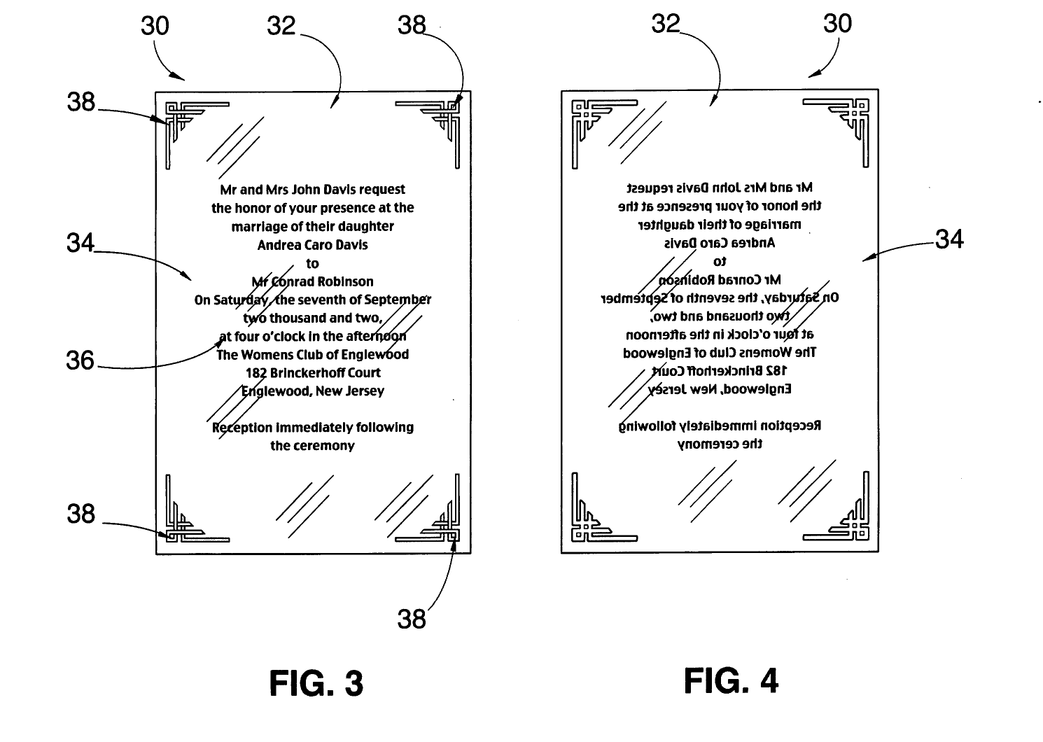

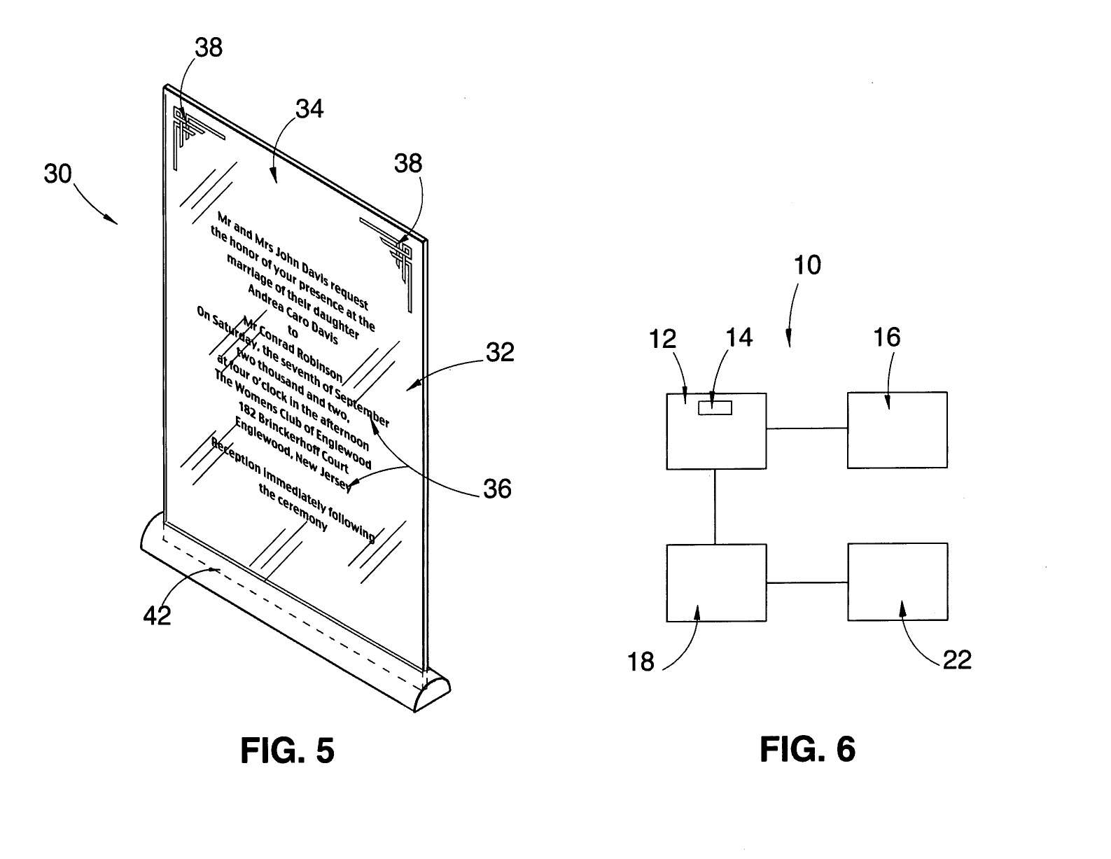

Reference is now made, more particularly, to FIGS. 1-6.

A method of engraving is provided. Such method includes providing a computer data system capable of receiving information, transmitting information, creating files, storing files, and editing files.

Providing an engraving software compatible with such computer data system. Operably connecting the engraving software to such computer data system.

Creating a file within such computer data system for use with the engraving software, such file containing predetermined information for engraving on an engravable item.

Operably connecting an engraving means to such computer data system for receiving instructional information relating to engraving from such computer data system. Transmitting such instructional information from such computer data system to the engraving means.

Providing an engravable item. Operably connecting the engravable item to the engraving means such that the engravable item is engraved according to such instructional information and such that the engravable item depicts a copy of such predetermined information once engraving is complete.

It is presently preferred that such method further includes painting a predetermined portion of the engravable item after the engravable item has been engraved.

According to another embodiment, an apparatus for engraving, generally designated 10, is provided. Referring to FIG. 6, such apparatus 10 includes a computer data system 12 capable of receiving information, transmitting information, creating files, storing files, and editing files.

Engraving software 14 is disposed within such computer data system 12, the engraving software 14 being operably connected to such computer data system 12 for receiving and transmitting information.

A means 16 for inputting information into at least one of the engraving software 14 and such computer data system is operably connected to such computer data system 12.

An engraving means 18 is operably connected to such computer data system 12 for receiving instructional information relating to engraving such that the engraving means 18 is capable of engraving an engravable item according to such instructional information such that the engravable item depicts predetermined information.

A means 22 for connecting the engraving means 18 to such engravable item during engraving is operably connected to the engraving means 22 at a predetermined location thereon.

It is presently preferred that such engraving means is an engraving machine.

It is presently preferred that such inputting means 16 is at least one of a keyboard, a scanner, a disk, a computer processing unit, and a combination thereof.

According to still another embodiment, an engraved decorative item, generally designated 30, is provided. Referring to FIGS. 1-5, such engraved decorative item 30 includes a decorative member 32 manufactured from a first predetermined material and having a first predetermined size and a first predetermined shape and having at least one engravable surface 34 at a first predetermined location thereon.

It is presently preferred that such first predetermined material is at least one of glass, plexiglass, plastic, and wood. It is presently most preferred that such first predetermined material is plexiglass.

Such decorative member 32 includes an engraved depiction 36 disposed thereon at a second predetermined location. It is presently preferred that such engraved depiction 36 is at least a partial copy of at least one of a wedding invitation, a bridal shower invitation, a baby shower invitation, a party invitation, a birth announcement, a graduation announcement, a retirement announcement, an engagement announcement, an award announcement, a marriage announcement, a scholarship announcement, a photograph and an inspirational message.

It is presently preferred that such engraved depiction 36 includes at least one of letters, numbers, pictures, symbols, and a combination thereof.

It is presently preferred that such engraved decorative item 30 includes a painted portion 38 at a predetermined location thereon. It is further presently preferred that such painted portion is painted with acrylic paint.

It is presently preferred that such engraved decorative item 30 includes a stand 42 manufactured from a second predetermined material and having a second predetermined size and a second predetermined shape, such stand 42 being operably connected to such decorative member 32 at a predetermined location thereon.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method of engraving comprising;
a. providing a computer data system capable of receiving information, transmitting information, creating files, storing files, and editing files;
b. providing an engraving software compatible with said computer data system;
c. operably connecting said engraving software to said computer data system;
d. creating a file within said computer data system for use with said engraving software, said file containing predetermined information for engraving on an engravable item;
e. operably connecting an engraving means to said computer data system for receiving instructional information relating to engraving from said computer data system;
f. transmitting said instructional information from said computer data system to said engraving means;
g. providing an engravable item; and
h. operably connecting said engravable item to said engraving means such that said engravable item is engraved according to said instructional information and such that said engravable item depicts a copy of said predetermined information once engraving is complete.

2. A method of engraving according to claim 1, wherein said method further includes painting a predetermined portion of said engravable item after said engravable item has been engraved.

3. An apparatus for engraving comprising;
a. a computer data system capable of receiving information, transmitting information, creating files, storing files, and editing files;
b. engraving software disposed within said computer data system, said engraving software being operably connected to said computer data system for receiving and transmitting information;
c. a means for inputting information into at least one of said engraving software and said computer data system, said means for inputting information being operably connected to said computer data system;
d. an engraving means operably connected to said computer data system for receiving instructional information relating to engraving such that said engraving means is capable of engraving an engravable item according to said instructional information such that such engravable item depicts predetermined information; and
e. a means for connecting said engraving means to such engravable item during engraving, said means for connecting being operably connected to said engraving means at a predetermined location thereon.

4. An apparatus for engraving according to claim 3 wherein said engraving means is an engraving machine.

5. An apparatus for engraving according to claim 3 wherein said inputting means is at least one of a keyboard, a scanner, a disk, a computer processing unit, and a combination thereof.

6. An engraved decorative item comprising;
a. a decorative member manufactured from a first predetermined material and having a first predetermined size and a first predetermined shape and having at least one engravable surface at a first predetermined location thereon; and
b. an engraved depiction disposed on said decorative member at a second predetermined location thereon.

7. An engraved decorative item according to claim 6 wherein said engraved depiction is at least a partial copy of at least one of a wedding invitation, a bridal shower invitation, a baby shower invitation, and a party invitation.

8. An engraved decorative item according to claim 6 wherein said engraved depiction is at least a partial copy of a birth announcement, a graduation announcement, a retirement announcement, an engagement announcement, an award announcement, a marriage announcement, and a scholarship announcement.

9. An engraved decorative item according to claim 6 wherein said engraved depiction is at least a partial copy of a photograph.

10. An engraved decorative item according to claim 6 wherein said engraved depiction is an inspirational message.

11. An engraved decorative item according to claim 6 wherein said engraved decorative item includes a painted portion at a predetermined location thereon.

12. An engraved decorative item according to claim 6 wherein said painted portion is painted with acrylic paint.

13. An engraved decorative item according to claim 6 wherein said first predetermined material is at least one of glass, plexiglass, plastic, and wood.

14. An engraved decorative item according to claim 12, wherein said first predetermined material is plexiglass.

15. An engraved decorative item according to claim 6 wherein said engraved decorative item includes a stand manufactured from a second predetermined material and having a second predetermined size and a second predetermined shape, said stand being operably connected to said decorative member at a predetermined location thereon.

16. An engraved decorative item according to claim 6 wherein said engraved depiction includes at least one of letters, numbers, pictures, symbols, and a combination thereof.
